(19) United States
(12) Patent Application Publication
(10) Pub. No.: US 2003/0217470 A1
(43) Pub. Date: Nov. 27, 2003

(54) Guide bar for a razor cartridge

(75) Inventors: Thomas A. Follo, Milford, CT (US); Paul Donald Richard, Shelton, CT (US)

Correspondence Address: Richard D. Getz, McCormick, Paulding & Huber LLP, 185 Asylum Street, CityPlace II, Hartford, CT, 06103, US

(73) Assignee: Warner-Lambert LLC, Morris Plains, NJ (US)

(21) Appl. No.: 10/352,813

(22) Filed: Jan. 28, 2003

Related U.S. Application Data
(60) Provisional application No. 60/353,056, filed on Jan. 30, 2002.
(60) Provisional application No. 60/395,657, filed on Jul. 12, 2002.

(51) Int. Cl. B26B 21/16

(52) U.S. Cl. 30/81; 30/50; 30/83; 30/77

(57) ABSTRACT

A razor cartridge is provided that includes a frame, one or more razor blades, a guard having a contact surface, and a plurality of scoop pockets disposed in the contact surface of the guard. The one or more razor blades are attached to the frame, and each has a cutting edge. The guard, which has a length and a width, is disposed forward of the one or more razor blades. Each of the scoop pockets has a base surface, a first side surface, and a second side surface that extend between an open end and an aft end. The open end of each scoop pocket is forward of the respective aft end. Each scoop pocket also includes an aft side surface contiguous with the aft end. The scoop pockets are distributed along the length of the guard.

This application claims the benefit of and incorporates by reference essential subject matter disclosed in U.S. Provisional Patent Application Nos. 60/353,056 filed on Jan. 30, 2002 and 60/395,657 filed on Jul. 12, 2002.

### BACKGROUND OF THE INVENTION

1. Technical Field.

This invention relates to shaving devices in general, and to shaving devices that utilize a guard bar in particular.

2. Background Information.

Modern safety razors utilize a plurality of blades disposed within a cartridge that is pivotally or rigidly mounted on a handle. Some safety razors have a disposable cartridge for use with a reusable handle, while others have a handle and cartridge that are combined into a unitary disposable. Although a variety of razor cartridge configurations exist, most include a frame made of a rigid plastic that includes a seat and a cap. Cartridges often include a guard disposed forward of the blades. The guard and the cap orient the position of the person's skin relative to the blades to optimize the shaving action of the blade. Some cartridges include a comfort strip comprised of shaving aids (e.g., lubricating agents, drag reducing agents, depilatory agents, cleaning agents, medicinal agents, etc.) to enhance the shaving process. The terms “forward” and “aft”, as used herein, define relative position between features of the safety razor (i.e., razor assembly). A feature “forward” of the razor blades, for example, is positioned so that the surface to be shaved encounters the feature before it encounters the razor blades, if the razor assembly is being stroked in its intended cutting direction (e.g., the guard is forward of the razor blades). A feature “aft” of the razor blades is positioned so that the surface to be shaved encounters the feature after it encounters the razor blades, if the razor assembly is being stroked in its intended cutting direction (e.g., the cap is disposed aft of the razor blades).

The comfort and performance provided by a particular razor cartridge are critical to the commercial success of the razor. Improvements that benefit razor comfort, performance, and ease of use, however significant or subtle, can have a decided impact on the commercial success of a razor. For example, most razors include a guard bar to orient the skin to be shaved in a favorable position for the one or more razors disposed aft of the guard. Guard bars typically orient the skin by gripping the skin and thereby causing it to be drawn taut during the shaving stroke. Fins, ribs, or other appendages that extend out from the skin-engaging surface of the guard exterior surface enhance the ability of the guard to grip the skin. In a wet shaving system where the user applies shaving cream, however, the appendages extending out from the guard undesirably wipe the shaving cream from the surface to be shaved.

What is needed, therefore, is a guard bar for a razor cartridge that favorably orients the skin to be shaved, and one that can be used with in a wet shaving system.

### DISCLOSURE OF THE INVENTION

It is, therefore, an object of the present invention to provide a guard bar for a razor cartridge that favorably orients the skin to be shaved, and one that can be used with in a wet shaving system.

According to the present invention, a razor cartridge is provided that includes a frame, one or more razor blades, a guard having a contact surface, and a plurality of scoop pockets disposed in the contact surface of the guard. The one or more razor blades are attached to the frame, and each has a cutting edge. The guard, which has a length and a width, is disposed forward of the one or more razor blades. Each of the scoop pockets has a base surface, a first side surface, and a second side surface that extend between an open end and an aft end. The open end of each scoop pocket is forward of the respective aft end. Each scoop pocket also includes an aft side surface contiguous with the aft end. The scoop pockets are distributed along the length of the guard.

An advantage of the present invention is that the scoop pockets provide an improved grip on the skin being shaved during the shaving stroke. The open scoop-shaped geometry of the scoop pockets provides an improved grip on the compliant skin because more of the compliant skin is received within the pocket than occurs with known guard designs. In addition, the geometry of the scoop pockets also permits the collection of excessive shaving cream without compromising the grip function of the scoop pockets.

Another advantage of the present invention is that the guard is easily cleaned of debris created during the shaving process. Prior art guards that include small projections alone and/or in combination with cavities can become clogged with debris. Once the guard is clogged with debris, its ability to grip the skin and thereby desirably orient the skin relative to the razor blades is undesirably compromised.

These and other objects, features, and advantages of the present invention will become apparent in light of the detailed description of the present invention.

### BRIEF DESCRIPTION OF THE DRAWINGS

FIG. 1 is a perspective view of a razor assembly.

FIG. 2 is a top view of the guard bar shown in FIG. 1.

FIG. 3 is a sectional view of the guard bar shown in FIGS. 1 and 2, sectioned along line 3-3.

FIG. 4 is a sectional view of a guard bar showing an alternative embodiment.

FIG. 5 is a perspective view of an embodiment of the present invention guard bar.

FIG. 6 is a top view of the guard bar shown in FIG. 5.

FIG. 7 is a sectional view of the guard bar shown in FIGS. 5 and 6, sectioned along the line 4-4.

FIG. 8 is top view of a razor cartridge showing an embodiment of the guard bar.

FIG. 9 is a front view of the razor cartridge shown in FIG. 8.

FIG. 10 is a sectional view of the razor cartridge shown in FIGS. 8 and 9, sectioned along line 10-10 as shown in FIG. 9.

### DETAILED DESCRIPTION OF THE INVENTION

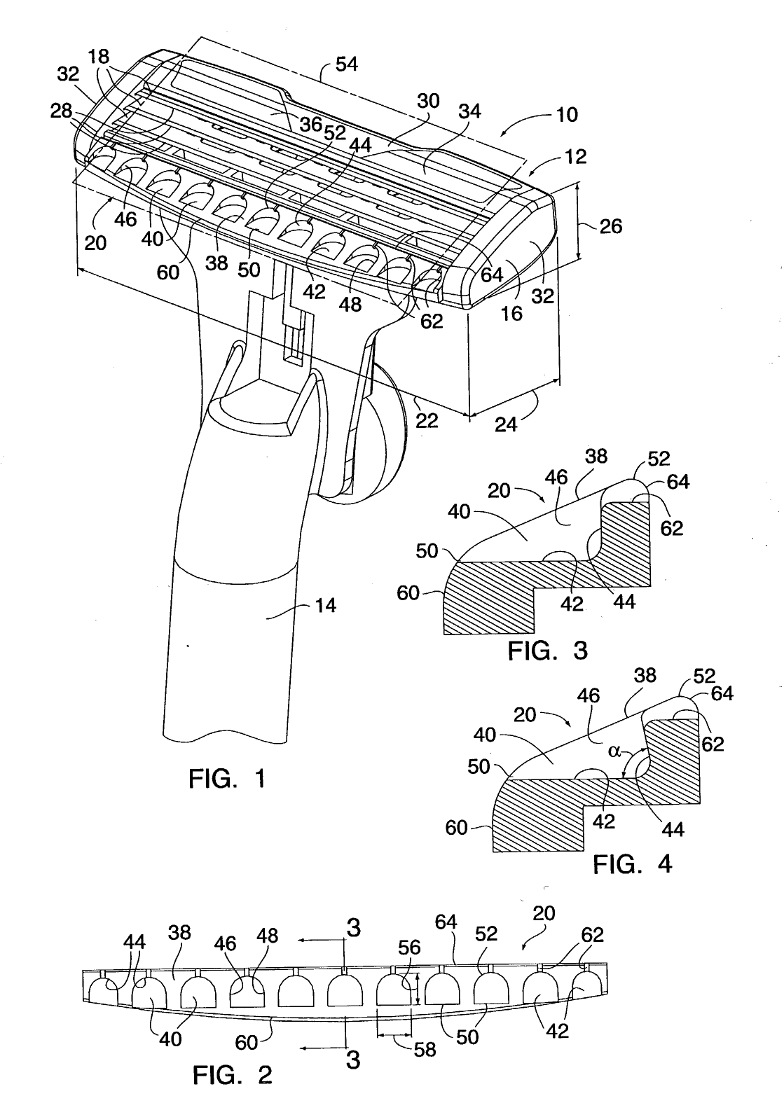

Now referring to FIGS. 1-10, the present invention razor assembly 10 includes a razor cartridge 12 and a handle 14. In some instances, the handle. 14 and cartridge 12 are assembled in a manner wherein disassembly of the cartridge 12 from the handle 14 during regular use is not intended (i.e., a unitary disposable razor assembly). In other instances, the cartridge 12 is replaceable and is therefore selectively detachable from the handle 14.

The razor cartridge 12 includes a frame 16, one or more razor blades 18, and a guard 20. The razor cartridge 12 can be described as having a length 22, a width 24, and a height 26. The one or more razor blades 18, each of which has a lengthwise-extending cutting edge 28, are attached to the frame 16. The frame 16 includes a cap 30 and a pair of side panels 32. The cap 30 is positioned aft of the one or more razor blades 18 and includes a contact surface 34. In some instances, a shaving aid strip 36 is attached to the cap 30. The shaving aid strip 36 can include one or more of a variety of constituent materials such as lubricating agents, drag reducing agents, depilatory agents, cleaning agents, medicinal agents, etc., and is not limited to any single material or combination of materials.

The guard 20 is attached to the frame 16, forward of the one or more razor blades 18. The guard 20 includes a contact surface 38 and a plurality of scoop pockets 40. The scoop pockets 40 are distributed along the length of the guard 20. Each of the scoop pockets 40 includes a base surface 42, an aft side surface 44, a first side surface 46, and a second side surface 48. The base, first side, and second side surfaces 42,46,48 extend between an open end 50 and an aft end 52. The aft side surface 44 is contiguous with the aft end 52. The open end 50 of each of the scoop pockets 40 is forward of the respective aft end 52. The guard 20 preferably comprises an elastomeric material that will enhance the ability of the guard 20 to grip the surface to be shaved.

In the embodiment shown in FIGS. 1-3, the aft and side surfaces 44,46,48 are substantially perpendicular to the base surface 42. The contact surface 38 of the guard 20 is at least in part contiguous with a shave plane 54 (see FIG. 1) that extends between the contact surface 38 of the guard 20 and the contact surface 34 of the cap 30, and extends across the length of the cartridge 12. The base surface 42 is substantially parallel the one or more razor blades 18. In alternative embodiments, as shown in FIG. 4, the aft side surface 44 and/or the first and second side surfaces 46,48 are skewed at an acute angle “α” relative to the base surface 42. The magnitude of the skew angle “α” can be altered from perpendicular to increase the ability of the guard 20 to grip the skin.

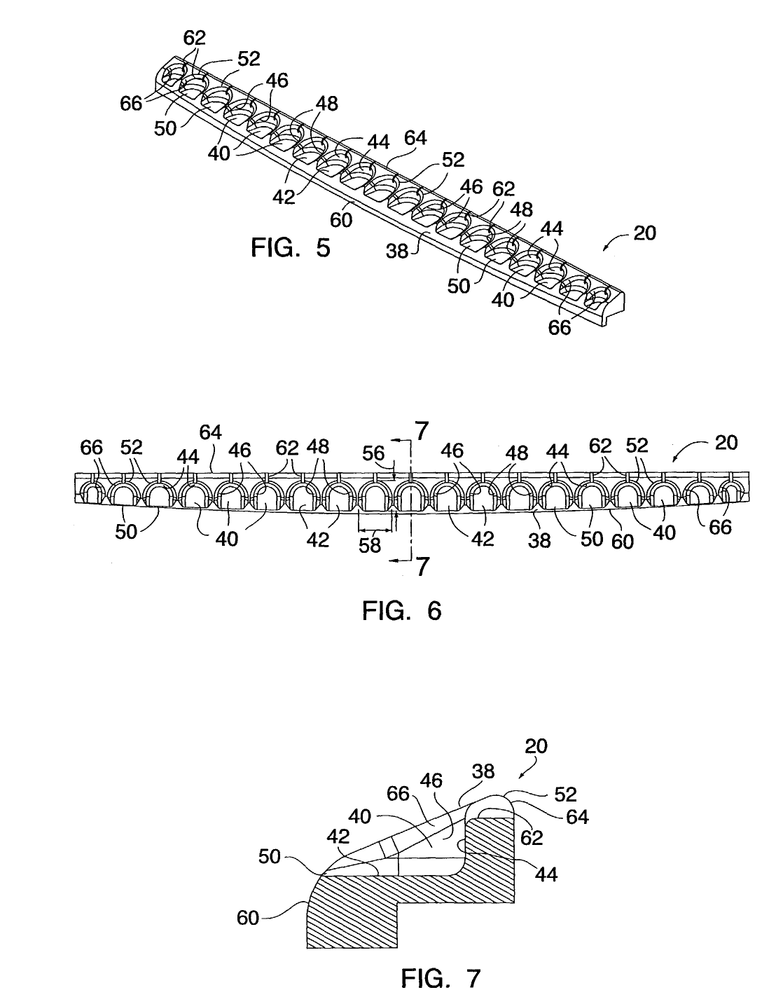

In the embodiment shown in FIGS. 1 and 2, the length 56 and width 58 of each of the scoop pockets 40 across the length of the guard 20 are equal, except those that are truncated by the geometry of the guard forward edge 60. In other embodiments, the length 56 and width 58 of the scoop pockets 40 can vary across the length of the guard 20. In the exemplary embodiment shown in FIGS. 5 and 6, the length 56 and width 58 of the scoop pockets 40 increase in the direction toward the center of the guard 20. The increased length 56 and width 58 increase the ability of the scoop pockets 40 to grip the skin. The length 56 and/or width 58 of each of the scoop pockets 40, and their position along the length of the guard 20 can be varied to suit the application. The exemplary embodiment shown in FIGS. 5-7 includes chamfered edges 66.

In some applications, the guard 20 further includes one or more channels 62 disposed in the contact surface 38 of the guard 20 extending between one or more of the scoop pockets 40 to an aft edge 64 of the guard 20. The channels 62, which extend toward the one or more razor blades 18, are sized to meter the release of shaving cream from the respective scoop pockets 40. The released shaving cream can act as a lubricant between the one or more razor blades 18 and the user's skin. An advantage provided by the combination of the scoop pockets 40 and the channels 62 is that the shaving cream cleared from the skin by a scoop pocket 40 can be released downstream of the same scoop pocket 40 without impeding the ability of that scoop pocket 40 to grip the skin. The position of the channel 62 aft of the scoop pocket 40 enhances the uniformity of the shaving cream distribution on the skin aft of the guard 20; i.e., shaving cream can pass between scoop pockets 40 and aft of the scoop pockets 40 via the channels 62, thereby providing a uniform lengthwise distribution.

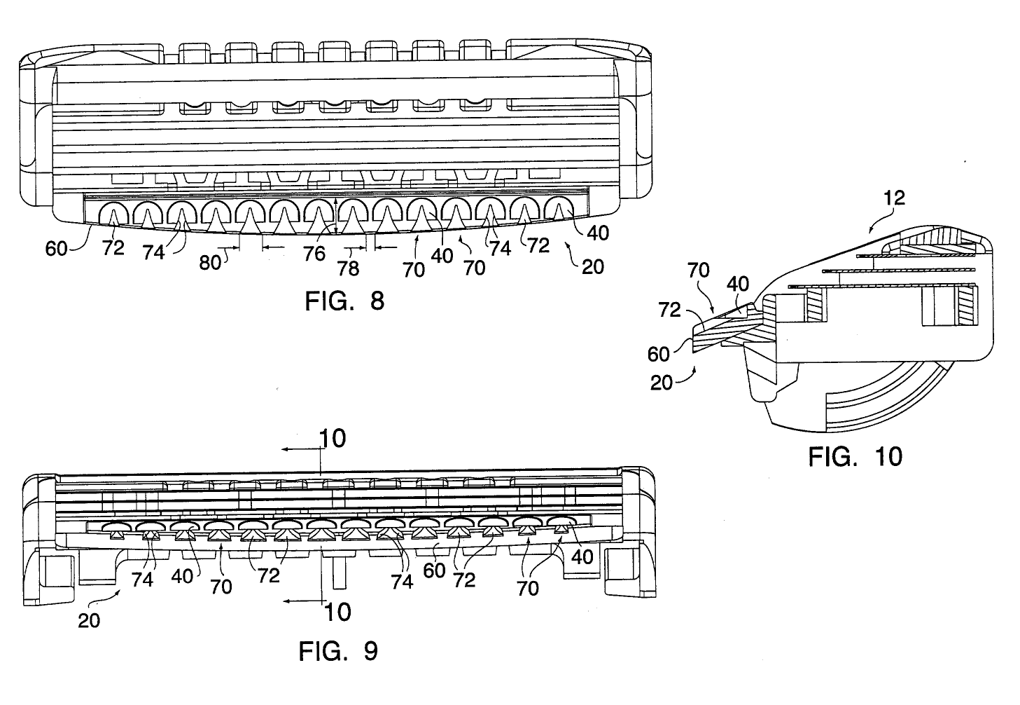

In the embodiment shown in FIGS. 8-10, the guard 20 further includes a plurality of notches 70 extending between the scoop pockets 40 and the forward edge 60 of the guard 20. FIGS. 8-10 show a notch 70 extending between each scoop pocket 40 and the forward edge 60. In some instances, there may be fewer notches 70 than scoop pockets 40. Each notch 70 has a base surface 72 and a pair of side surfaces 74. The base surface 72 is positioned substantially parallel with the shave plane 54 (see FIG.1) of the razor cartridge 12. The side surfaces 74 diverge from one another traveling in the direction from the scoop pocket 40 to the forward edge 60. The side surfaces 74 are shown arcuately shaped, but can be otherwise shaped alternatively. The forward edge 60 of the guard 20 embodiment shown in FIGS. 8-10, is arcuately shaped. The distance between adjacent notches 70 at the forward edge 60 of the guard 20 is influenced by the increased width 76 in the center of the arcuately shaped guard 20 and the divergent notch side surfaces 74. Specifically, the distance 78 between notches 70 decreases as one travels from either side toward the center of the guard 20. In addition, the length 80 of each notch 70 at the forward edge 60 increases in similar manner.

In the operation of the razor assembly 10, the skin to be shaved is typically disposed contiguous with the “shave” plane 54 (see FIG. 1) that extends tangentially between the contact surface 38 of the guard 20 and the contact surface 34 of the cap 30. If the user applies sufficient force normal to the shave plane 54, the compliant skin will bulge around rigid elements of the razor cartridge 12 adjacent the shave plane 54, and thereby extend below the shave plane 54. Skin bulging between razor blades 18 is susceptible to undesirable irritation. To avoid undesirable irritation, the function of the guard 20 to grip the skin and cause it to be pulled taut during the shaving stroke, thereby improving the orientation of the skin (e.g., decrease the bulge) relative to the one or more razor blades 18.

The scoop pockets 40 within the guard 20 of the present invention razor cartridge 12 provide an improved mechanism for gripping the skin. Specifically, the open scoop-shaped geometry of the scoop pockets 40 provides an improved grip on the skin because more of the skin is received within the scoop pocket 40 than occurs with known guard designs. As the razor cartridge 12 is drawn along, the force necessary to remove the skin from the scoop pockets 40 favorably draws the skin taut. The geometry of the scoop pockets 40 also permits the collection of excessive shaving cream without compromising the grip function of the scoop pockets 40. In the embodiment shown in FIGS. 8-10, the notches 70 facilitate uniform distribution of shaving cream.

Although this invention has been shown and described with respect to the detailed embodiments thereof, it will be understood by those skilled in the art that various changes in form and detail thereof may be made without departing from the spirit and scope of the invention.

What is claimed is:

1. A razor cartridge, comprising:
a frame having a cap;
one or more razor blades attached to the frame, wherein each razor blade has a cutting edge; and
a guard having a length, a width, and a contact surface, wherein the guard is disposed forward of the one or more razor blades; and
a plurality of scoop pockets disposed in the contact surface of the guard, each scoop pocket having an open end, an aft end, a base surface, a first side surface, a second side surface, and an aft side surface, wherein the base, first side, and second side surfaces extend between the open end and the aft end, wherein the scoop pockets are distributed along the length of the guard; and
wherein the open end of the pockets is forward of the aft end to enable a surface to be shaved to enter into the pockets.

2. The razor cartridge of claim 1, wherein the aft side surface is arcuately shaped.

3. The razor cartridge of claim 2, wherein the aft side surface is substantially perpendicular the base surface.

4. The razor cartridge of claim 2, wherein the aft side surface is skewed at an acute angle relative to the base surface.

5. The razor cartridge of claim 4, wherein one or both of the first side surface and the second side surface is skewed at an acute angle relative to the base surface.

6. The razor cartridge of claim 5, wherein the guard comprises an elastomeric material.

7. The razor cartridge of claim 6, wherein the base surface is substantially parallel the one or more razor blades.

8. The razor cartridge of claim 1, wherein the base surface is substantially parallel the one or more razor blades.

9. The razor cartridge of claim 8, wherein the aft side surface is substantially perpendicular the base surface.

10. The razor cartridge of claim 8, wherein the aft side surface is skewed at an acute angle relative to the base surface.

11. The razor cartridge of claim 10, wherein one or both of the first side surface and the second side surface is skewed at an acute angle relative to the base surface.

12. The razor cartridge of claim 1, wherein each of the scoop pockets has a length and a width, and the lengths of the scoop pockets are uniform.

13. The razor cartridge of claim 12, wherein the widths of the scoop pockets are uniform.

14. The razor cartridge of claim 1, wherein each of the scoop pockets has a length and a width, and the lengths of the scoop pockets vary.

15. The razor cartridge of claim 14, wherein the lengths of the scoop pockets located at each lengthwise end of the guard are less than the length of the scoop pockets located in the center region of the guard.

16. The razor cartridge of claim 15, wherein the widths of the scoop pockets vary.

17. The razor cartridge of claim 16, wherein the widths of the scoop pockets located at each lengthwise end of the guard are less than the width of the scoop pockets located in the center region of the guard.

18. The razor cartridge of claim 1, wherein each of the scoop pockets has a width and a length, and the widths of the scoop pockets vary.

19. The razor cartridge of claim 18, wherein the widths of the scoop pockets located at each lengthwise end of the guard are less than the widths of the scoop pockets located in the center region of the guard.

20. The razor cartridge of claim 1, further comprising one or more channels disposed in the contact surface of the guard extending between the plurality of scoop pockets and an aft edge of the guard.

21. The razor cartridge of claim 1, further comprising:
a plurality of notches disposed in the guard, extending between one of the scoop pockets and a forward edge of the guard, wherein each notch includes a base surface and a pair of side surfaces.

22. The razor cartridge of claim 21, wherein the side surfaces of each notch diverge from one another traveling in the direction from the scoop pocket to the forward edge.

23. The razor cartridge of claim 22, wherein the base surface of each notch is substantially parallel with a shave plane of the razor cartridge.

24. The razor cartridge of claim 23, wherein the side surfaces of each notch are arcuately shaped.

25. A razor assembly, comprising:
a cartridge having a:
a frame having a cap;
one or more razor blades attached to the frame, wherein each razor blade has a cutting edge; and
a guard having a length, a width, and a contact surface, wherein the guard is disposed forward of the one or more razor blades; and
a plurality of scoop pockets disposed in the contact surface of the guard, each scoop pocket having an open end, an aft end, a base surface, a first side surface, a second side surface, and an aft side surface, wherein the base, first side, and second side surfaces extend between the open end and the aft end, wherein the scoop pockets are distributed along the length of the guard; and
wherein the open end of the pockets is forward of the aft end to enable a surface to be shaved to enter into the pockets; and
a handle.

26. The razor assembly of claim 25, wherein the aft side surface is arcuately shaped.

27. The razor assembly of claim 26, wherein the aft side surface is skewed at an acute angle relative to the base surface.

28. The razor assembly of claim 25, wherein one or both of the first side surface and the second side surface is skewed at an acute angle relative to the base surface.

29. The razor assembly of claim 28, wherein the base surface is substantially parallel the one or more razor blades.

30. The razor assembly of claim 25, wherein each of the scoop pockets has a length and a width, and the lengths of the scoop pockets are uniform.

31. The razor assembly of claim 25, wherein the widths of the scoop pockets are uniform.

32. The razor assembly of claim 25, wherein each of the scoop pockets has a length and a width, and the lengths of the scoop pockets vary.

33. The razor assembly of claim 32, wherein the widths of the scoop pockets vary.

34. The razor assembly of claim 25, further comprising one or more channels disposed in the contact surface of the guard extending between the plurality of scoop pockets and an aft edge of the guard.
